(19) United States
(12) Patent Application Publication
(10) Pub. No.: US 2019/0011017 A1
(43) Pub. Date: Jan. 10, 2019

(54) DOUBLE CLUTCH TRANSMISSION AND METHOD FOR OPERATING A DOUBLE CLUTCH TRANSMISSION

(71) Applicant: ZF Friedrichshafen AG, Friedrichshafen (DE)

(72) Inventors: Stefan BLATTNER, Vogt (DE); Christian MITTELBERGER, Ravensburg (DE)

(21) Appl. No.: 15/549,882

(22) PCT Filed: Jan. 11, 2016
(86) PCT No.: PCT/EP2016/050334

§ 371 Date: Jan. 25, 2018

(30) Foreign Application Priority Data
Feb. 10, 2015 (DE) 10 2015 202 350.8

(51) Int. Cl. F16H 3/097; F16H 3/00; F16D 21/06; F16H 3/093; F16H 3/08

(52) U.S. Cl. CPC F16H 3/097; F16H 3/006; F16H 2003/0826; F16H 2003/0933; F16H 2200/0056; F16D 21/06

(57) ABSTRACT

A transmission having two clutches which engage to drive respective input shafts coaxially arranged along an input axis on an input side of the transmission. An output shaft outputs drive from both input shafts. The transmission has a plurality of wheel planes and shifting elements. A first countershaft extends along a countershaft axis over all the wheel planes and a coaxial, hollow second countershaft has transmission elements of two wheel planes. A shifting element couples the countershafts. At least six forward gears can be engaged including overdrive and direct gears. An additional gear, having a gear ratio greater than one, can be obtained by actuating only one shifting element. The direct gear can be obtained by actuating one shifting element and the overdrive gear can be engaged by actuating two shifting elements axially arranged on a side of the shifting element that actuates the additional gear facing the input side.

This application is a National Stage completion of PCT/EP2016/050334 filed Jan. 11, 2016, which claims priority from German patent application serial no. 10 2015 202 350.8 filed Feb. 10, 2015.

### FIELD OF THE INVENTION

The invention concerns a dual clutch transmission for use in motor vehicles, comprising two clutches, two sub-transmissions wherein each sub-transmission comprises at least one input shaft and wherein the two input shafts are arranged on a drive input side on an input shaft axis, an output shaft on a drive output side of the transmission which is the drive output shaft of both sub-transmissions, a plurality of wheel planes and in particular at most seven wheel planes and a plurality of shifting elements, in particular at most seven shifting elements, and a countershaft arrangement having at least one countershaft axis on which at least two countershafts are arranged, and in which one of the countershafts extends in the axial direction of the transmission over all the wheel planes whereas the other countershaft, which is a hollow shaft, is arranged parallel to and coaxially with the first countershaft, on which transmission elements of two wheel planes are arranged and connected in a fixed manner, and a shifting element for coupling the two countershafts is provided, and wherein by means of the transmission six forward gears including an overdrive gear and a direct gear can be obtained, such that the direct gear can be obtained by actuating one shifting element and the overdrive gear can be obtained by actuating at least one shifting element.

The invention also concerns a method for operating a dual clutch transmission, such that the dual clutch transmission comprises two clutches, a plurality of wheel planes and in particular at most seven wheel planes, a plurality of shifting elements and in particular at most seven shifting elements, and a countershaft arrangement having at least one countershaft axis on which at least two countershafts are arranged, in which one of the countershafts extends in the axial direction of the transmission over all the wheel planes whereas the other countershaft, which is a hollow shaft, is arranged parallel to and coaxially with the first countershaft, on which transmission elements of two wheel planes are arranged and connected in a fixed manner, and a shifting element for coupling the two countershafts is provided, and wherein by means of the transmission six forward gears including an overdrive gear and a direct gear can be obtained, such that the direct gear can be obtained by actuating one shifting element and the overdrive gear can be obtained by actuating at least one shifting element.

The invention further concerns a method for operating a dual clutch transmission, wherein a first gear is obtained by closing a first clutch and also closing the third and sixth shifting elements, and wherein a second gear is obtained by closing a second clutch and also closing the second shifting element, and wherein a third gear is obtained by closing the first clutch and also closing the third shifting element, and wherein a fourth gear is obtained by closing the second clutch and also closing the fifth shifting element.

### BACKGROUND OF THE INVENTION

Transmissions for motor vehicles are designed, among others, as so-termed dual clutch transmissions in which in each case an input shaft is associated with a sub-transmission and in which the input shafts of the two sub-transmissions can be connected by a respectively associated powershift element with a drive input such as a combustion engine or an electric motor, the two powershift elements then being combined in the form of a dual clutch. The gears that can be produced by means of such a transmission are then divided in alternation between the two sub-transmissions, so that for example one sub-transmission produces the odd-numbered gears and the corresponding other sub-transmission produces the even-numbered gears. It is also known to produce the individual gear steps by means of one or more gearwheel stages or planes, each with a different gear ratio step. By virtue of corresponding shifting elements these can be connected into the force or torque flow between the drive input and the drive output, so that a corresponding desired transmission ratio is produced in each case between the drive input and the drive output.

Thanks to the alternate division of the gears between the two sub-transmissions it is possible, while driving in a gear associated with one of the sub-transmissions, already to preselect a subsequent gear in the respective other sub-transmission by appropriate actuation of the shifting devices, so that an eventual shift to the subsequent gear is enabled by opening the powershift element of the one sub-transmission and, shortly after, closing the powershift element of the other sub-transmission. In this way the gears or gear steps of the transmission can be shifted under load, which improves both the ability of the motor vehicle to accelerate and the comfort of gearshift processes for the vehicle's driver, since the gearshift takes place essentially without traction force interruption.

Such dual clutch transmissions can also be made with an intermediate countershaft arrangement in addition to the drive input and the drive output, so that a more compact structure is produced in the axial direction.

Such a transmission 1 is known, for example, from DE 10 2004 043 387 A1.

This has the disadvantage that the number of gears that can be obtained with the transmission corresponds essentially to the number of wheel planes, i.e. for example with seven wheel planes including a reversing gear stage a total of six forward gears are available, including a direct gear.

### SUMMARY OF THE INVENTION

An objective of the present invention is therefore to make available a dual clutch transmission and a method for operating a dual clutch transmission, which can provide at least one further gear. A further objective of the present invention is to provide an alternative dual clutch transmission and an alternative method for operating a dual clutch transmission.

The present invention achieves these objectives with a dual clutch transmission for use in motor vehicles, which comprises two clutches, two sub-transmissions each of which comprises at least one input shaft, and wherein on a drive input side the two input shafts are arranged on an input shaft axis, an output shaft on a drive output side of the transmission which is the drive output shaft of both sub-transmissions, a plurality of wheel planes and in particular at most seven wheel planes, a plurality of shifting elements and in particular at most seven shifting elements, and a countershaft arrangement with at least one countershaft axis on which at least two countershafts are arranged, one of the countershafts extending in the axial direction of the transmission over all the wheel planes whereas the other of the two countershafts, which is a hollow shaft, is arranged parallel to and coaxially with the first countershaft, on which transmission elements of two wheel planes are arranged in fixed connection and wherein a shifting element is provided for coupling the two countershafts, and such that by means of the transmission six forward gears including an overdrive gear and a direct gear can be obtained, in which the direct gear can be obtained by actuating one shifting element and the overdrive gear by actuating two shifting elements, in that besides the six gears an additional gear, in particular a forward gear, can be obtained in the transmission, this additional gear having a gear ratio greater than 1 and being obtained by actuating only one shifting element, and in particular wherein the two shifting elements are arranged on that side of the shifting element for actuating the additional gear which faces toward the drive input side.

The present invention also achieves the objectives with a method for operating a dual clutch transmission, such that the dual clutch transmission comprises: two clutches, a plurality of wheel planes and in particular at most seven wheel planes, and a plurality of shifting elements and in particular at most seven shifting elements, and a countershaft arrangement with at least one countershaft axis on which at least two countershafts are arranged, one of the countershafts extending in the axial direction of the transmission over all the wheel planes whereas the other of the two countershafts, which is a hollow shaft, is arranged parallel to and coaxially with the first countershaft, on which transmission elements of two wheel planes are arranged in fixed connection and wherein a shifting element is provided for coupling the two countershafts, and such that by means of the transmission six forward gears including an overdrive gear and a direct gear can be obtained, in which the direct gear can be obtained by actuating one shifting element and the overdrive gear by actuating at least one shifting element, in that a gear additional to the six gears already available has a gear ratio greater than unity and is formed by the actuation of only one shifting element whereas the overdrive gear is obtained by actuating at least two shifting elements, in particular such that the two shifting elements are arranged on that side of the shifting element for actuating the additional gear which faces toward the drive input side.

The present invention also achieves the objectives with a method for operating a dual clutch transmission, such that a first gear is obtained by closing a first clutch and also closing the third and sixth shifting elements, and a second gear is obtained by closing the second clutch and the sixth shifting element, and a third gear is obtained by closing the first clutch and the second shifting element, and a fourth gear is obtained by closing the second clutch and the fifth shifting element, in that a fifth gear is obtained by closing the second clutch and the fourth shifting element, and a sixth gear, particularly in the form of a direct gear, is obtained by closing the first clutch and the first shifting element, and a seventh gear in the form of an overdrive gear is obtained by closing the second clutch and also closing the first and third shifting elements.

The invention also achieves the objectives with a motor vehicle, in particular a passenger car or a truck, having a transmission according to the invention.

One of the advantages achieved thereby is that without substantial structural modifications an additional gear can be made available, which is advantageous for the use of the transmission in a variety of vehicles. A further advantage is that in this way at least partial powershiftability of the transmission is achieved. Another advantage is that with the same structural effort and expense a greater spread or smaller gear intervals are made possible.

The term “wheel stage” or “wheel plane” in the description and particularly in the claims is preferably understood to mean essentially two transmission elements that co-operate to transmit torques from one transmission element to the other transmission element, such that preferably a stepped-down or stepped-up ratio is obtained in particular for transmission shafts that co-operate with the transmission elements.

The term “shifting element” in the description and particularly in the claims is preferably understood to mean a device which has at least an open and a closed condition, such that in the open condition the device does not transmit any torque and in the closed condition the device can transmit a torque between two devices that co-operate with the device or shifting element.

The term “shifting device” in the description and particularly in the claims is preferably understood to mean at least one shifting element and at least one shifting element actuating device for actuating the at least one shifting element.

The term “transmission element” in the description and particularly in the claims is preferably understood to mean a device by means of which force and/or torque can be transmitted. Here, transmission elements can preferably be in the form of wheels, preferably gearwheels and in particular spur gears, bevel gears, worm gears or the like.

The term “double shifting element” in the description and particularly in the claims is preferably understood to mean two shifting elements and two separate shifting element actuating devices, particularly in the form of sliding sleeves, which can be actuated in such manner that at least one of the two shifting elements is closed and at the same time the respective other shifting element is open.

Other advantageous embodiments, features and advantages of the invention are described below.

Expediently, the overdrive gear is obtained by means of the two wheel planes closest to the drive input side. This keeps the path as short as possible, so that a reliable force and torque transmission from the drive input side to the drive output side of the dual clutch transmission is enabled.

Advantageously, one of the two shifting elements for actuating the overdrive gear is arranged on the input shaft axis and the other of the two shifting elements is arranged on the countershaft axis. In this way the axial fitting space of the shifting elements for obtaining the overdrive gear can be reduced.

Advantageously, the additional gear and the overdrive gear can be obtained by actuating the same clutch. This allows the additional gear to be obtained in a simple manner.

Expediently, the overdrive gear and the direct gear can be obtained by means of the same shifting element, especially when the shifting element is arranged next to the drive input side in the transmission. In this way the shifting element, when it is arranged next to the drive input side, can be maintained simply. At the same time the number of shifting elements for producing the gears is reduced.

Expediently, in the shifting sequence from high to low gear ratios the additional gear can be engaged before, in particular immediately before the direct gear. In this way the lower gears as far as the gear ratio concerned can remain unchanged as regards their actuation of clutches and shifting elements.

Advantageously, the shifting elements for obtaining the direct gear and/or the overdrive gear are arranged close to at least two other shifting elements on the drive output side of that shifting element for obtaining the direct gear and/or the overdrive gear which is arranged farthest toward the drive output side. What this achieves is that the shifting elements for the direct gear and the overdrive gear are not arranged in the area of the drive output side.

Expediently, the additional gear can be partially powershifted via the direct gear by means of a support gearshift. This gives at least partial powershiftability.

Expediently, the additional gear is designed to be the fifth forward gear, the direct gear being the sixth forward gear and/or the overdrive gear being the seventh forward gear. One of the advantages achieved thereby is that as regards their actuation, the first four gears do not have to be modified, and this reduces the complexity for producing the transmission, and hence also the production costs.

Expediently one of the wheel planes, in particular the wheel plane closest to the drive output side, is designed as the reversing gear stage. One of the advantages achieved thereby is that at least one reversing gear can be made available by the transmission, which is advantageous as regards the flexibility of the transmission for use in a variety of vehicles.

Expediently, the shifting element next to and near the drive output side is made as a single shifting element and/or at least two and in particular all of the other shifting elements are in the form of double shifting elements. If all the other shifting elements are made as double shifting elements, the production complexity and hence the production costs of the transmission are reduced. For example, if the reversing gear stage is actuated by means of the single shifting element, this enables the reversing gear stage to be coupled or connected into the torque transmission path of the transmission particularly reliably. At the same time the single shifting element can be maintained more simply on the drive output side.

Expediently, the first six shifting elements beginning from the drive input side are in each case arranged in pairs, in alternation on the input shaft axis and the countershaft axis, particularly in each case in the form of double shifting elements. One of the advantages achieved thereby is that the fitting space in the axial direction of the dual clutch transmission can be reduced in that way.

Expediently, between the two shifting elements for engaging the overdrive gear there is arranged at least one further shifting element in the sequence of shifting elements along the axis of the transmission. In this way the flexibility of the transmission can be increased still more as regards the coupling of various wheel planes for the production of gears.

Advantageously, more than half of the shifting elements are arranged on the input shaft axis of the transmission. In this way the fitting space for a countershaft arrangement can be reduced considerably.

Advantageously, the fifth gear is engaged partly under load by way of the sixth gear by means of a support gearshift. This allows at least partial powershiftability to be achieved in a simple manner.

Further important features and advantages of the invention emerge from the subordinate claims, from the drawings and from the associated figure descriptions relating to the drawings.

It is understood that the features mentioned above and those still to be explained can be used not only in the combination indicated in each case, but also in other combinations or as stand-alone features, without going beyond the scope of the present invention.

Preferred designs and embodiments of the present invention are illustrated in the drawings and will be explained in more detail in the description given below, wherein the same indexes denote the same, or similar, or functionally equivalent components or elements.

### BRIEF DESCRIPTION OF THE DRAWINGS

The figures show, in each case schematically:

FIG. 1: A transmission according to a first embodiment of the present invention; and

FIGS. 2, 2A: A shifting matrix for a transmission according to the first embodiment of the present invention.

### DETAILED DESCRIPTION OF THE PREFERRED EMBODIMENTS

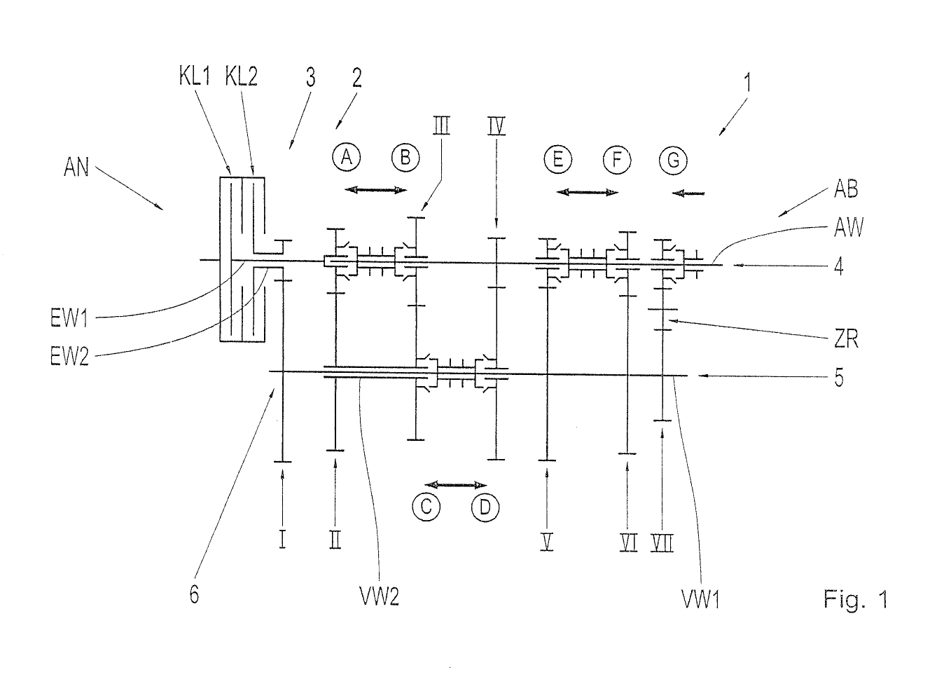

FIG. 1 shows a transmission according to a first embodiment of the present invention.

In FIG. 1 the index 1 denotes a transmission in the form of a dual clutch transmission. The dual clutch transmission 1 comprises two powershift elements in the form of clutches KL1, KL2. By means of the dual clutch KL1, KL2, the drive input side AN can be coupled or connected to the drive output side AB of the transmission 1 for the transmission of force and torques. For this, the first clutch is connected to a first input shaft EW1 and the second clutch KL2 is connected to a second input shaft EW2. The first input shaft EW1 is a solid shaft whereas the second input shaft EW2 is a hollow shaft. The two input shafts EW1, EW2 are arranged parallel to and coaxially with one another. The two clutches KL1, KL2 can be connected to a motor, for example by way of a drive input shaft.

Furthermore, the transmission comprises two sub-transmissions 2, 3. The first sub-transmission 2 is coupled with the first input shaft EW1 and the second sub-transmission with the second input shaft EW2.

In addition the transmission 1 has an input shaft axis 4 on which the two input shafts EW1, EW2 are arranged. Downstream in relation to the torque and force flow from the drive input side AN of the transmission 1 and beginning from the two clutches KL1, KL2, the transmission 1 comprises first a first wheel plane I, then a second wheel plane II, a first shifting element A, a second shifting element B, a third wheel plane III, a fourth wheel plane IV, a fifth wheel plane V, a fifth shifting element E, a sixth shifting element F, a sixth wheel plane VI, a seventh wheel plane VII and a seventh shifting element G. Each of the wheel planes I, II, III, IV, V, VI and VII has transmission elements, in particular in the form of gearwheels, each of which is and/or can be connected to a shaft of the transmission 1.

Parallel to the input shaft axis 4 is arranged a countershaft axis 5 for a countershaft arrangement 6. The countershaft arrangement 6 comprises a countershaft VW1 in the form of a solid shaft with a countershaft VW2 in the form of a hollow shaft arranged coaxially with and parallel to it. Between the input shaft axis 4 and the countershaft axis 5 the seventh wheel plane VII has an intermediate wheel ZR for reversing the rotation direction, so that by means of the drive output shaft AW and with the same rotation direction of one of the input shafts EW1, EW2 a reversed rotation direction is enabled for the provision of at least one reversing gear. Thus, the seventh wheel plane VII is designed as the reversing gear stage.

Beginning from the drive input side AN, the countershaft axis 5 has the first wheel plane I, the second wheel plane II, the third wheel plane III, a third shifting element C, a fourth shifting element D, the fourth wheel plane IV, the fifth wheel plane V, the sixth wheel plane VI and the seventh wheel plane VII.

Below, the seven shifting elements A, B, C, D, E, F and G will now be described.

The first shifting element A is arranged on the input shaft axis 4 and is connected on one side to the first input shaft EW1 and to a transmission element of the second wheel plane II, and on the other side to the drive output shaft AW, and when actuated it forms a connection for the transmission of force and torques between the input shaft EWI, the second wheel plane II and the drive output shaft AW.

The second shifting element B is arranged on the input shaft axis 4 and is connected on one side to a transmission element of the third wheel plane III and on the other side to the drive output shaft AW. When actuated, it couples the drive output shaft AW to the third wheel plane III.

The third shifting element C is arranged on the countershaft axis 5 and is connected on one side to the first countershaft VW1 and on the other side to the second countershaft VW2. When actuated, it couples the first countershaft VWI to the second countershaft VW2.

The fourth shifting element D is arranged on the countershaft axis 5 and is connected on one side to a transmission element of the fourth wheel pane IV and on the other side to the first countershaft VW1. When actuated, it couples the first countershaft VW1 to the fourth wheel plane IV.

The fifth shifting element E is arranged on the input shaft axis 4 and, when actuated, it couples the first countershaft VW1 to the drive output shaft AW by way of the fifth wheel plane V.

The sixth shifting element F is arranged on the input shaft axis 4 and, when actuated, it couples the first countershaft VW1 to the drive output shaft AW by way of the sixth wheel plane VI.

The seventh shifting element G is arranged on the input shaft axis 4 and, when actuated, it couples the first countershaft VW1 to the drive output shaft AW by way of the seventh wheel plane VII.

The shifting elements A and B, and C and D, and E and F are in each case combined in respective double shifting elements and can in each case be actuated by a respective shared shifting element actuating device. The seventh shifting element G is a single shifting element.

On the first countershaft VW1 are arranged in a fixed manner transmission elements of the first wheel plane I, the fifth wheel plane V, the sixth wheel plane VI and the seventh wheel plane VII.

On the second countershaft VW2 are arranged in a fixed manner transmission elements of the second wheel plane II and the third wheel plane III. On the drive output shaft AW is arranged in a fixed manner the transmission element of the fourth wheel plane IV. On the first input shaft EW1 is arranged in a fixed manner the transmission element of the second wheel plane II on the input shaft axis 4, and on the second input shaft EW2 is arranged in a fixed manner the transmission element of the first wheel plane I.

The transmission 1 according to FIG. 1 has seven wheel planes Ito VII, with the seventh wheel plane VII designed as the reversing gear stage. All the wheel planes I to VII are in particular in the form of spur gear stages with discrete gear ratios. Each of the wheel planes Ito VII has two transmission elements, in particular in the form of gearwheels. The reversing gear stage has between the input shaft axis 4 and the countershaft axis 5 an additional, intermediate wheel ZR for reversing the rotation direction. Thus a total of fifteen transmission elements, in particular in the form of gearwheels, are provided for the wheel planes.

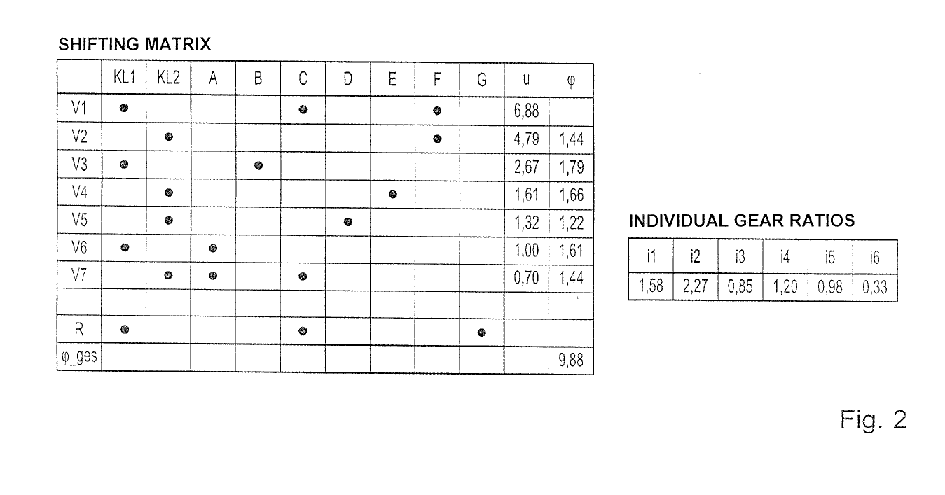

FIG. 2 shows a shifting matrix for a transmission according to a first embodiment of the present invention.

In FIG. 2 a shifting matrix for the transmission 1 according to FIG. 1 is shown. In this, columns for the shifting elements A, B, C, D, E, F, and G and for the two clutches KL1 and KL2 are shown. In addition the absolute gear ratio u and the relative gear ratio y are shown. Furthermore, the respective individual gear ratios i1, i2, i3, i4, i5, i6 for the wheel planes of the forward gears V1, V2, V3, V4, V5, V6, V7 are shown in FIG. 2A. The relative gear ratio φ is shown in each case between the next-lowest gear and the current gear.

Perpendicularly downward are shown first the seven forward gears, denoted by the indexes Vi to V7, and a reversing gear denoted by R. Cells in the shifting matrix left empty, for example for the forward gear V1 the shifting elements A, B, E and G and the clutch KL2, indicate that the corresponding shifting element or clutch is in this case open, i.e. that here the shifting element or clutch is transmitting no forces or torques between the respective shaft or shafts associated with or connected to the shifting element or clutch concerned. A cell containing a dot in the shifting matrix indicates that the corresponding shifting element or clutch is actuated or closed, for example in the shifting matrix for the forward gear V1 the clutch KL1 and the shifting elements C and F.

Unless otherwise described in what follows, all the clutches KL1 and KL2 and all the shifting elements A to G are in each case open.

To obtain the first forward gear V1 of the transmission 1, according to FIG. 2 the clutch KL1 and the shifting elements C and F are closed. The absolute gear ratio u is 6.88.

To obtain the second forward gear V2, the clutch KL2 and the shifting element F are closed. The absolute gear ratio is 4.79 and the relative gear ratio is 1.44.

To obtain the third forward gear V3, the clutch KL1 and the shifting element B are dosed. The absolute gear ratio is 2.67 and the relative gear ratio is 179.

To obtain the fourth forward gear V4, the clutch KL2 and the shifting element E are closed. The absolute gear ratio is 1.61 and the relative gear ratio is 1.66.

To obtain the fifth forward gear V5, the clutch KL2 and the shifting element D are dosed. The absolute gear ratio is 1.32 and the relative gear ratio is 1.22.

To obtain the sixth forward gear V6, the clutch KL1 and the shifting element A are closed. The absolute gear ratio is 1.00 and the relative gear ratio is 1.61.

To obtain the seventh forward gear V7, the clutch KL2 and the shifting elements A and C are closed. The absolute gear ratio is 0.70 and the relative gear ratio is 1.44.

To obtain the reversing gear R, the clutch KL1 and the shifting elements C and C are closed.

The total relative gear ratio amounts to 9.88. In FIG. 2A the respective individual gear ratios i1 to i6 for the corresponding wheel planes Ito VI are indicated: i1=1.58, i2=2.27, i3=0.85, i4=1.20, i5=0.98 and i6=0.33.

All told, the transmission elements can in particular be in the form of gearwheels, preferably spur gears, so that the wheel planes I to VII are spur gear stages. To obtain various forward and reversing gears, i.e. various gear ratios, the spur gear stages and in particular their gearwheels can correspondingly provide different gear ratios.

In summary the present invention offers, among other things, the advantage that at least one additional gear can be made available with the same fitting space. A further advantage is that a larger spread or smaller gear intervals are made possible.

Although the present invention has been described above with reference to preferred example embodiments, it is not limited to these but can be modified in many ways.

### INDEXES

1 Transmission
2 First sub-transmission
3 Second sub-transmission
4 Input shaft axis
5 Countershaft axis
6 Countershaft arrangement
I, II, III, IV, V, VI, VII Wheel plane
KL1, KL2 First/Second powershift element
A, B, C, D, E, F, G Shifting element
VW1, VW2 Countershaft
ZR Intermediate wheel
AN Drive input side
AB Drive output side
V1, V2, V3, V4, V5, V6, V7 Forward gear
R Reversing gear

1-18. (canceled)

19. A dual clutch transmission (1) for use in a motor vehicle, the transmission (1) comprising:
two clutches (KL1, KL2),
two sub-transmissions (2, 3), with each of the sub-transmissions (2, 3) comprising at least one input shaft (EW1, EW2), and the two input shafts (EW1, EW2) being arranged on an input shaft axis (4) on a drive input side (AN),
an output shaft on a drive output side of the transmission (1) being a drive output shaft (AW) for both of the sub-transmissions (2, 3),
a plurality of wheel planes (I, II, III, IV, V, VI, VII),
a plurality of shifting elements (A, B, C, D, E, F, G),
a countershaft arrangement (6) with at least one countershaft axis (5), on which at least first and second countershafts (VW1, VW2) being arranged, and in which
the first countershaft (VW1) extending in an axial direction of the transmission (1) over all the wheel planes (I, II, Ill, IV, V, VI, VII),
the second countershaft (VW2) being a hollow shaft arranged parallel to and coaxially with the first countershaft (VW1), on which transmission elements of two wheel planes (II, Ill) are arranged in a fixed manner, and
one of the shifting elements (C) for coupling the first and the second countershafts (VW1, VW2) is provided,
via the transmission (1) six forward gears (V1, V2, V3, V4, V5, V6, V7) including an overdrive gear (V7) and a direct gear (V6) can be obtained,
the direct gear (V6) being obtainable by actuating a shifting element (A),
an additional gear (V5), in additional to the six forward gears, can be provided by the transmission (1) such that:
the additional gear (V5) providing a gear ratio of the transmission (1) greater than one and can be obtained by actuating only one shifting element (D), and
the overdrive gear (V7) is obtainable by actuating at least two of the shifting elements (A, C), the two shifting elements (A, C) being arranged on a side of the shifting element (D), for actuating the additional gear (V5), that faces toward the drive input side (AN).

20. The dual clutch transmission according to claim 19, wherein the overdrive gear (V7) is obtainable by two wheel planes (I, II) next and closest to the drive input side (AN).

21. The dual clutch transmission according to claim 19, wherein a first (A) of the two shifting elements for actuating the overdrive gear (V7) is arranged on the input shaft axis (4) and a second (C) of the two shifting elements is arranged on the countershaft axis (5).

22. The dual clutch transmission according to claim 19, wherein the additional gear (V5) and the overdrive gear (V7) are obtainable by actuating the same clutch (KL2).

23. The dual clutch transmission according to claim 19, wherein the overdrive gear (V7) and the direct gear (V6) are obtainable by the same shifting element (A), and this shifting element (A) is arranged next to the drive input side (AN) in the transmission (1).

24. The dual clutch transmission according to claim 19, wherein during a shift sequence from high to lower gear ratios, the additional gear (V5) is engagable immediately before the direct gear (V6).

25. The dual clutch transmission according to claim 19, wherein the shifting elements (A; A, C) for obtaining at least one of the direct gear (V6) and the overdrive gear (V7) are arranged close to at least two further shifting elements (E, F, G) on the drive output side (AB) of that shifting element (C) for obtaining that at least one of the direct gear (V6) and the overdrive gear (V7) which is arranged farthest toward the drive output side (AB).

26. The dual clutch transmission according to claim 19, wherein the additional gear (V5) is partially powershiftable by way of the direct gear (V6) by a support gearshift.

27. The dual clutch transmission according to claim 19, wherein the additional gear (V5) is a fifth forward gear (5), the direct gear (V6) is a sixth forward gear (V6) and the overdrive gear (V7) is a seventh forward gear (V7).

28. The dual clutch transmission according to claim 19, wherein one wheel plane (VII), closest to the drive output side (AB), is designed as the reversing gear stage.

29. The dual clutch transmission according to claim 19, wherein the shifting element (G) closest to the drive output side (AB) is a single shifting element and all of the other shifting elements (A, B; C, D; E, F) are double shifting dements,

30. The dual clutch transmission according to claim 19, wherein beginning from the drive input side (AN), the first six shifting elements (A, B, C, D, E F) are arranged in pairs (A, B; C, D; E, F) in a form of respective double shifting elements positioned, in alternation, on the input shaft axis and on the countershaft axis.

31. The dual clutch transmission according to claim 19, wherein between the two shifting elements (A, C) for engaging the overdrive gear (V7) at least one further shifting element (B) is arranged in sequence of the shifting elements (A, B, C, D, E, F, G) along the transmission axis (4, 5).

32. The dual clutch transmission according to claim 19, wherein more than half of the shifting elements (A, B, C, D, E, F, G) are arranged on the input shaft axis (4) of the transmission (1).

33. A method for operating a dual clutch transmission (1), the dual clutch transmission comprises: two clutches (KL1, KL2); a plurality of wheel planes (I, II, III, IV, V, VI, VII); a plurality of shifting elements (A, B, C, D, E, F, G); a countershaft arrangement (6) with at least one countershaft axis (5), on which at least first and second countershafts (VW1, VW2) are arranged, the first countershaft (VW1) extends in an axial direction of the transmission (1) over all of the wheel planes (I, II, III, IV, V, VI, VII), and the second countershaft (VW2) is a hollow shaft arranged parallel to and coaxially with the first countershaft (VW1), on which transmission elements of two wheel planes (II, III) are arranged in a fixed manner, and in which a shifting element (C) is provided for coupling the first and the second countershafts (VW1, VW2); and via the transmission (1) six forward gears (V1, V2, V3, V4, V5, V6, V7) including an overdrive gear (V7) and a direct gear (V6) are obtained, the method comprising:
obtaining the direct gear (V6) by actuating a shifting element (A),
obtaining an additional gear (V5), in additional to the six forward gears, by actuating only one shifting element (D), and the additional gear providing a gear ratio of the transmission (1) greater than one, and
obtaining the overdrive gear (V7) by actuating the two shifting elements (A, C) arranged on a side of the shifting element (D) for actuating the additional gear (V5) which faces toward the drive input side (AN).

34. The method for operating a dual clutch transmission, in particular according to claim 33, further comprising:
obtaining a first gear (V1) by engaging a first clutch (KL1) and also engaging a third and a sixth shifting elements (C, F),
obtaining a second gear (V2) by engaging a second clutch (KL2) and also engaging the sixth shifting element (F),
obtaining a third gear (V2) by engaging the first clutch (KL1) and also engaging the second shifting element (B),
obtaining a fourth gear (V4) by engaging the second clutch (KL2) and also engaging a fifth shifting element (E),
obtaining a fifth gear (V5) is obtained by engaging the second clutch (KL2) and also engaging a fourth shifting element (0),
obtaining a sixth gear, in the form of the direct gear, by engaging the first clutch (KL1) and also engaging a first shifting element (A), and
obtaining a seventh gear (V7), in the form of the overdrive gear, by engaging the second clutch (KL2) and also engaging the first and third shifting elements (A, C).

35. The method according to claim 34, further comprising engaging the fifth gear (V5) partially under load by way of the sixth gear (V6) by a support gearshift.

36. A motor vehicle in combination with a dual clutch transmission (1), comprising:
first and second clutches (KL1, KL2);
first and second sub-transmissions (2, 3), with each of the first and the second sub-transmissions (2, 3) comprising an input shaft (EW1, EW2), the input shafts (EW1, EW2) of the first and the second sub-transmissions being arranged on an input shaft axis (4) on a drive input side (AN);
an output shaft (AW) being arranged on a drive output side of the transmission (1), and the output shaft being a drive output for both of the first and the second sub-transmissions (2, 3),
first, second, third, fourth, fifth, sixth and seventh wheel planes (I, II, III, IV, V, VII),
first, second, third, fourth, fifth, sixth and seventh shifting elements (A, B, C, D, E, F, G),
a countershaft arrangement (6) arranged on a countershaft axis (5), the countershaft arrangement comprising first and second countershafts (VW1, VW2) and the third shifting element (C), the first countershaft (VW1) extending in an axial direction of the transmission (1) over all of the first, the second, the third, the fourth, the fifth, the sixth and the seventh wheel planes (I, II, III, IV, V, VI, VII), the second countershaft (VW2) being a hollow shaft arranged parallel to and coaxially with the first countershaft (VW1), and transmission elements of the second and the third wheel planes (II, III) being connected to the second countershaft in a fixed manner, and the third shifting element (C) coupling the first and the second countershafts (VW1, VW2),
at least six forward gears (V1, V2, V3, V4, V5, VS, V7) are obtainable by means of the transmission (1), with the six forward gears comprising an overdrive gear (V7) and a direct gear (V6),
the direct gear (V6) being obtained by actuating the first shifting element (A),
a further forward gear (V5), in addition to the six forward gears, being provided by the transmission (1),
the further forward gear (V5), having a gear ratio of the transmission (1) greater than one, being obtainable by actuating only the fourth shifting element (D), and
the overdrive gear (V7) being obtainable by actuating the first and the third shifting elements (A, C), and the first and the third shifting elements (A, C) being arranged on an axial side of the fourth shifting element (D) that faces the drive input side (AN).
